(19) United States
(12) Patent Application Publication
(10) Pub. No.: US 2010/0058248 A1
(43) Pub. Date: Mar. 4, 2010

(54) GRAPHICAL USER INTERFACES FOR BUILDING MANAGEMENT SYSTEMS

(75) Inventor: Youngchoon Park, Brookfield, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/549,312

(22) Filed: Aug. 27, 2009

Related U.S. Application Data
(60) Provisional application No. 61/093,189, filed on Aug. 29, 2008.

(51) Int. Cl. G06F 3/048

(52) U.S. Cl. 715/851

(57) ABSTRACT

A method for generating a graphical user interface for a building management system is described. The method includes rendering a graphical representation of a three dimensional object in the graphical user interface. One or more surfaces of the graphical representation of the three dimensional object includes a plurality of windows. Each window is configured to host a widget for displaying information from the building management system. The method further includes receiving data from the building management system for the widgets. The method yet further includes rendering the widgets using the data received from the building management system. The method also includes interpreting user input and rotating the graphical representation of the three dimensional object based on the interpretation.

### CROSS-REFERENCE TO RELATED APPLICATIONS

The present application claims the benefit of U.S. Provisional Application No. 61/093,189, filed Aug. 29, 2008, which is incorporated herein by reference in its entirety.

### BACKGROUND

The present disclosure generally relates to the field of building management systems. The present disclosure relates more specifically to graphical user interfaces for building management systems.

### SUMMARY

One embodiment relates to a method for generating a graphical user interface for a building management system at a client device. The method includes rendering a graphical representation of a three dimensional object in the graphical user interface. One or more surfaces of the graphical representation of the three dimensional object include a plurality of windows. Each window is configured to host a widget for displaying information from the building management system. The method further includes receiving data from the building management system for the widgets. The method yet further includes rendering the widgets using the data received from the building management system. The method also includes interpreting user input and rotating the graphical representation of the three dimensional object based on the interpretation.

Another embodiment relates to a system for displaying a graphical user interface for a building management system on a client device. The system includes a presentation server configured to determine how to present the graphical user interface on the client device using information received from the client device and information received from a user permissions resource. The presentation server is further configured to generate presentation descriptions and to provide the presentation descriptions to the client device. The system further includes a graphical user interface engine local to the client device and configured to receive and parse the presentation descriptions received from the presentation server to load graphical user interface widgets stored in memory local to the graphical user interface engine. The graphical user interface engine is further configured to provide requests to data delivery processes of the presentation server to gather building management system data for the graphical user interface widgets. The graphical user interface engine is yet further configured to cause the graphical user interface widgets populated with data received in response to the requests to be displayed on an electronic display connected to the client device. The client device, using the graphical user interface engine, is advantageously configured to load, maintain, animate, interact with user input, render, and otherwise operate using local resources.

Such a system is intended to provide client devices with well defined and described data resources (e.g., definitions and descriptions provided by the presentation server) so that the client devices can generate the requests for the data delivery processes. Processing resources of the client are primarily spent on display and user interaction tasks while the presentation server or other building management system resources use their resources for data delivery processes, execution of business logic, execution of workflows, and the like. This system may advantageously reduce network bandwidth between the client device and BMS resources while also reducing the processing time the presentation server must spend, for example, creating dynamic web pages for transmitting in whole to clients. The client device can advantageously display graphics and animation rich user interfaces without making frequent requests for user interface resources to a remote server.

Another embodiment relates to computer-readable media with computer-executable instructions embodied thereon that when executed by a computing device generate a graphical user interface for a building management system. The media includes instructions for rendering a graphical representation of a three dimensional object in the graphical user interface. One or more surfaces of the graphical representation of the three dimensional object include a plurality of windows. Each window is configured to host a widget for displaying information from the building management system. The media further includes instructions for receiving data from the building management system for the widgets. The media yet further includes instructions for rendering the widgets using the data received from the building management system. The media also includes instructions for interpreting user input and rotating the graphical representation of the three dimensional object based on the interpretation.

Alternative exemplary embodiments relate to other features and combinations of features as may be recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a building management system, according to an exemplary embodiment;

FIGS. 2A-B are illustrations of graphical user interfaces generated by systems and methods of the present application, according to various exemplary embodiments;

FIG. 2C is a block diagram of a GUI including a graphical carousel, according to an exemplary embodiment;

FIG. 2D is a flow chart of a process for completion by a presentation server and for creating and sending a presentation description to a graphical user interface engine of a client device, according to an exemplary embodiment;

FIG. 3A is a diagram of a building management system, according to an exemplary embodiment;

FIG. 3B is an illustration of an exemplary presentation description provided from the presentation planning system of FIG. 3A to the client's GUI engine;

FIG. 3C is an illustration of an exemplary user action description provided to the presentation server or data delivery processes thereof from the GUI engine;

FIG. 3D is an illustration of another exemplary user action description provided to the presentation server or data delivery processes thereof from the GUI engine;

FIG. 3E is a flow chart of a process for using the building management system of FIG. 3A to generate, for example, the graphical user interfaces shown in FIGS. 2A-B, according to an exemplary embodiment;

FIGS. 4A-E are illustrations of graphical user interfaces generated by systems and methods of the present disclosure, according to various exemplary embodiments;

FIG. 5A is a flow chart of a process for providing a graphical user interface for a building management system, according to an exemplary embodiment; and

FIG. 5B includes block diagrams of the client device and presentation server described herein, according to various exemplary embodiments.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the Figures, systems and methods for providing a graphical user interface (GUI) for a building management system are shown and described. The GUI provided to the user may include a graphical representation of a three dimensional object (e.g., a cylinder, a cube, a prism, etc.). The graphical representation of the three dimensional object includes one or more surfaces having a plurality of windows and may be rotated. Such a graphical representation of the three dimensional object is frequently referred to throughout this application as a “graphical carousel.” Each window is configured to host a widget for displaying information from the building management system. Systems and methods are also described for providing content rich and design rich graphical user interfaces such as the graphical carousel remotely from subsystems or data sources of a related building management system.

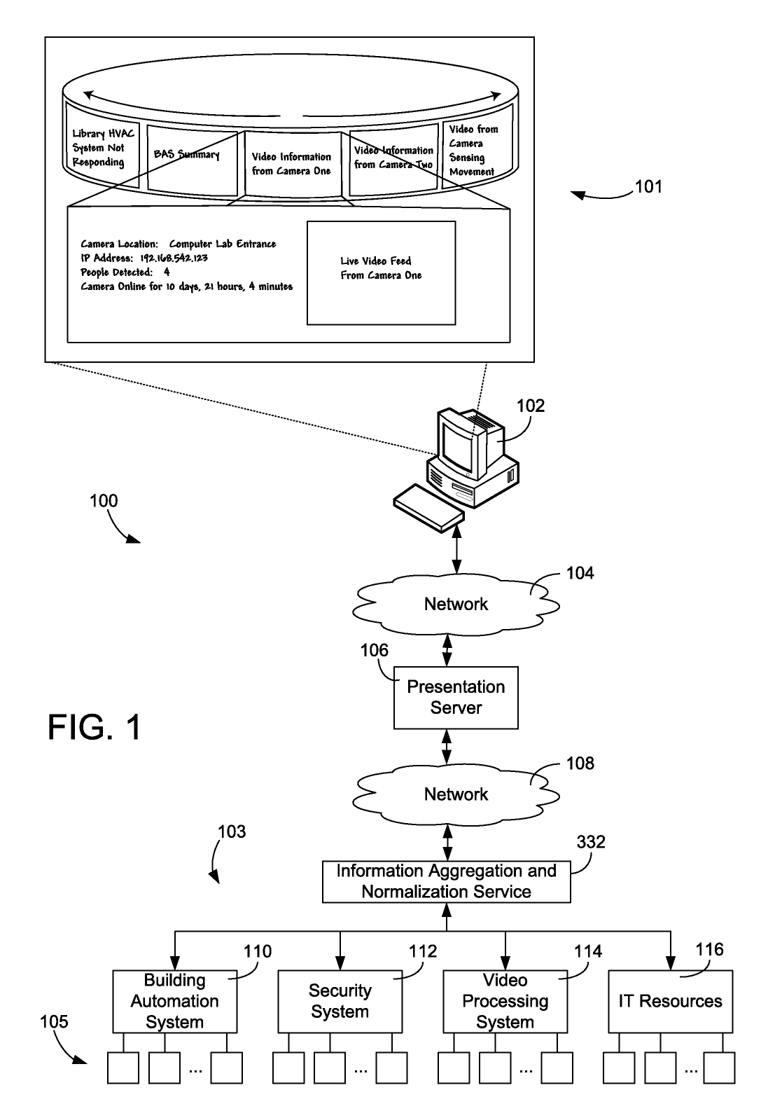

Referring to FIG. 1, a block diagram of a building management system (BMS) 100 is shown, according to an exemplary embodiment. BMS 100 is shown to include a client terminal 102 having an electronic display on which GUIs such as GUI 101 may be displayed. Client terminal 102 is configured to access BMS subsystems or data sources 103 via networks 104, 108 and presentation server 106. The GUIs provided to the electronic display of client terminal 102 are variously configured to allow users (e.g., building manager, building engineer, security manager, etc.) to monitor, configure, control, or otherwise affect the operation of building management system 100. Client terminal 102 may be located at a user station, front desk, remotely from the building or site being managed, or any other area. In an exemplary embodiment, software of client terminal 102 may be configured to cause a GUI including, for example, GUI 101 having a graphical carousel, to be displayed.

Client terminal 102 is shown connected to presentation server 106 via network 104. Presentation server 106 is configured to facilitate the display of GUIs such as GUI 101 for BMS 100 on client devices such as client device 102. Presentation server 106 is more particularly configured to use information about a user accessing BMS 100 and information about client 102 to provide customized GUI layouts, workflows, GUI controls, and data from BMS subsystems and resources 103 to the client devices for processing and display. In an exemplary embodiment, presentation server 106 is configured to use inputs and outputs to/from BMS subsystems and data resources 103 to allow interrelationships between the data to be viewed or acted upon by users of the client devices.

While in some embodiments presentation server 106 is configured to communicate directly with BMS subsystems and resources 103, in other embodiments one or more information aggregation and normalization services 332 are present in BMS 100. Information aggregation and normalization service 332 is configured to resolve formatting, timing or protocol-based differences between various BMS subsystems and resources 103. Information aggregation and normalization service 332 may further be configured to provide a normalized interface for interaction by presentation server 106. Accordingly, a data request from presentation server 106 can be formatted according to a common protocol regardless of the BMS subsystems from which the data will actually be extracted. Series of data may also be aggregated for extraction by or for pushing to presentation server 106 for display on client device 102 as a summary. Information aggregation and normalization service 332 may also time synchronize information for better use by presentation server 106. For example, events received from different BMS subsystems may arrive at differing times in differing formats but be highly related. Information aggregation and normalization service 332 may be configured to resolve these temporal and formatting differences so that the events can be related by the presentation server 106, logic of the information aggregation and normalization service, or otherwise.

BMS 100 is shown to include building automation system (BAS) 110, security system 112, video processing system 114, and IT resources 116. BAS 110 may generally be a hardware and/or software system configured to control, monitor, and manage equipment in or around a building or building area. BAS 110 equipment may generally include a heating, ventilation, and air conditioning (HVAC) system, a lighting system, fire alerting system, elevator system, and any other system capable of managing building functions. BAS 110 may generally provide data and other information regarding various BAS devices 105 (e.g., field controllers, field devices, temperature sensors, air handling units, etc.) of BAS 110 to presentation server 106 (e.g., upon request, automatically, etc.). According to an exemplary embodiment, BAS 110 may be a Metasys system sold by Johnson Controls, Inc.

Security system 112 is shown coupled to presentation server 106 via network 108 and may generally provide presentation server 106 with security data regarding the building or building area. Security system 112 may include, for example, a user access (e.g., based on RFID card access, key-based access, biometrics access, etc.) or tracking system for a building or campus. Security system 112 may include or be coupled to a video surveillance system for video surveillance, an event management system to detect a security-related event in the building area, a motion detection system, an emergency response system, an ID management system, or any other security related subsystem.

Video processing system 114 is coupled to presentation server 106 via network 108. Video processing system 114 may provide any of BMS subsystems 103 with video data, video processing results data, video descriptions, determined events relating to video, or any other video-related data. For example, video or stills of door locks, lights, or other objects or events in the building area may be captured by video processing system 114. Video processing system 114 may include one or more modules configured to interpret video as including particular events or objects and to communicate metadata messages describing the events or objects to other BMS subsystems or data sources 103 or to presentation server 106.

IT resources 116 may be coupled to presentation server 106 via network 108. IT resources 116 may include switches, hubs, firewalls, IT servers, wireless access points and the like. In embodiments where IT resources 116 are connected to BMS 100, graphical user interfaces at the client may be configured to use data from IT resources 116 (e.g., network addresses, network naming conventions, active directory resources, etc.), or to configure aspects of IT resources 116 (e.g., user permissions, server load, etc.).

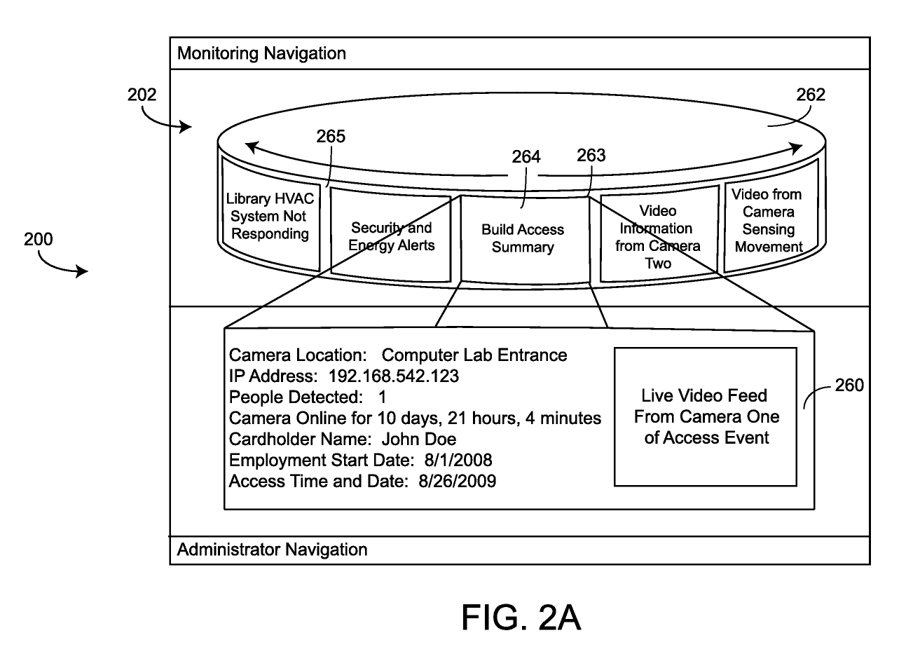

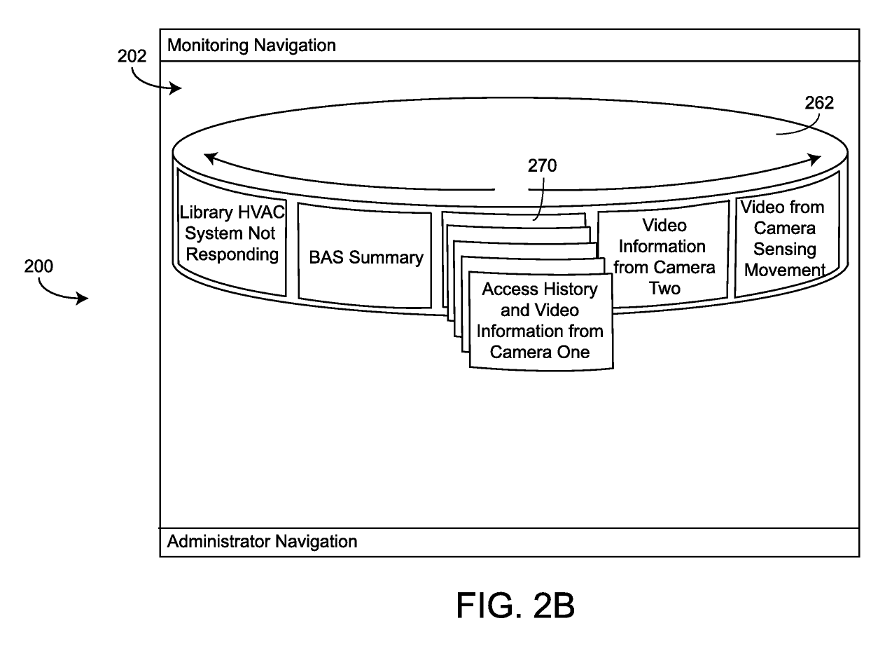

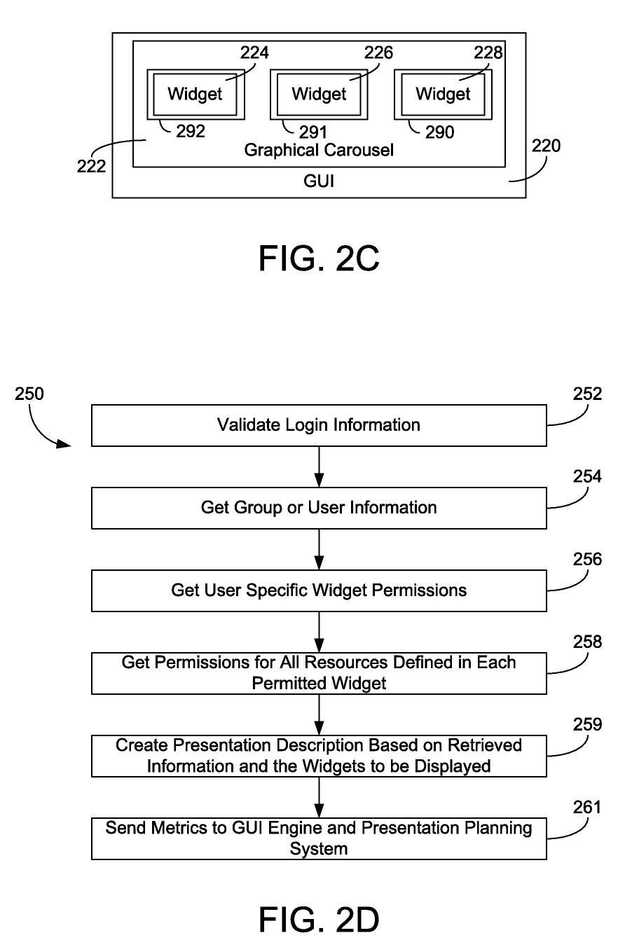

Referring now to FIG. 2A, an exemplary GUI 200 is shown that client device 102 may display. GUI 200 is configured to be locally rendered and displayed by a GUI engine of the client using resources stored on the client. Which contents are shown by the GUI engine, the layout, and other data, however, are generally received by the client from the presentation server. GUIs provided by the systems and methods described herein are configured to be dynamic and content rich. One aspect of the GUIs' dynamic nature is the existence of multiple movable panes of data. In FIG. 2A, GUI 200 is shown to include a pane 202 for displaying information of different types to a user of the GUI. Pane 202 is shown as a monitoring pane or “monitoring navigation section.” Another aspect of the GUI's dynamic nature is the use of widgets within the GUI. A widget 260 is shown as being generated in response to use interaction with another widget 264 hosted in a window 263 on the surface 265 of carousel 262. A widget is an application or applet for display on the graphical user interface and for providing a rendering of data provided by the BMS. Each widget can include multiple user interface controls for receiving user input. Each widget can also include multiple display elements such as streaming text, summary information, live video, graphics, graphs, or other displays generated using information from the BMS (e.g., BMS subsystems, an information normalization and aggregation service, a presentation server, etc.). Each widget may be associated with at least one service or subsystem of the BMS. Many of the widgets shown in a graphical user interface according to the present disclosure, however, will include summary information, fused information, aggregate information, or another combination of information from multiple services or subsystems of the BMS. For example, widget 260 is shown as providing information regarding a building access event. Widget 260 not only includes text information from a security system or access system, but also includes video information (e.g., a camera location and IP address, the number of people in view of the camera or other building area properties, a time and duration associated with the camera, etc.), IT resource information, human resources information, and the like. The video information may be provided by a video security server or other video monitoring system of BMS 100.

The widgets may be stored local to the client device or downloaded for later loading and execution on the client device. The widgets may be provided (or launched) based on a user request, automatically via a server process (e.g., a widget for alarms may be provided when an alarm is active), or otherwise. The widget appearance and setup may be changed by a user (e.g., the placement of the widget in GUI 200, the style of display, etc.), changed by a system administrator pushing appearance settings to users, or otherwise.

Monitoring pane 202 is shown to include a graphical carousel 262 for displaying and navigating between multiple widgets. According to other exemplary embodiments, monitoring pane 202 may include a different three dimensional object. Graphical carousel 262 is configured to include a plurality of windows (e.g., display areas, panes, widget hosts) on one or more of the surfaces of graphical carousel 262 for hosting widgets (e.g., displaying widgets, containing widgets, etc.). In FIG. 2A, widget 264 is shown as the currently selected widget of graphical carousel 262. A user of graphical carousel 262 may rotate (e.g., scroll, spin, move, shift, transform, slide) graphical carousel 262 to select or interact with a widget displayed on carousel 262. For example, graphical carousel 262 may rotate in response to a user input (e.g., a user may select a button to rotate graphical carousel 262 to the left or right to scroll between multiple windows), may cause a new window of information to be displayed in response to a user input (e.g., video information may be displayed upon user selection of the window hosting the video information widget), etc. Graphical carousel 262 may further be configured to rotate in response to receiving alarm or event data (or other data) such that a widget associated with the alarm or event data is brought into view of the user. Graphical carousel 262 is shown as cylindrical, where the side surface of the cylinder includes the plurality of windows configured to host widgets. According to other embodiments, graphical carousel 262 may be of any geometric shape (e.g., cubic, rectangular, etc.) or size. In the context of graphical carousel 262, rotating the carousel means causing the graphical representation of the graphical carousel to appear to rotate. The appearance of rotation may be provided by animation of the graphical carousel and by, for example, rotating widgets of the carousel into view or out of view.

The windows and graphical carousel 262 may generally be configured to host one or more widgets for displaying information from BMS 100. The selection or interaction with a widget of graphical carousel 262 can cause one or more reports, windows, or other widgets to be displayed to the user on top of, instead of, below (as shown by widget 264), or otherwise oriented relative to graphical carousel 262.

Referring also to FIG. 2B, graphical carousel 262 may provide layered widgets hosted by the windows. In the embodiment of FIG. 2B, widget 270 is shown as layered. Widget 270 may include more than one layer, and may display the layers as stacked extending away from the surface of graphical carousel 262. As shown in FIG. 2B, widget 270 may include video information from a camera, and each layer may include video information from different building areas, different times, or otherwise. A user may select widget 270 and then scroll through the layers. For example, a user may select widget 270 and scroll through the layers, each layer representative of a time of day the video information was recorded. According to other embodiments, the layers may represent different subsystems of a system of the BMS, different videos of a video security system, multiple alarms associated with the BMS, different reports for the BMS, or otherwise.

According to various exemplary embodiments, carousel 262 may be configured to rotate up or down instead of left and right, or carousel 262 may be configured to rotate in any direction. In the embodiments of FIGS. 2A-B, carousel 262 is shown in whole, according to other exemplary embodiments, parts of carousel 262 may be obscured when scrolling (e.g., only two or three windows at a time may be shown, etc.).

Referring to FIG. 2C, a block diagram of a GUI window 220 is shown, according to an exemplary embodiment. Graphical carousel 222 (or another graphical display system) may be displayed in GUI window 220 and may host multiple widgets 224-228 within windows 290, 291, 292. Each widget 224-228 may receive data from one or more subsystems of the BMS via the presentation server. For example, widget 224 may receive data from an access history database via the presentation server. Another widget 226 may receive device status data from the presentation server and from a plurality of BMS subsystems. For example, the status of an HVAC system, security system, lighting system, or any other building system may be provided to widget 226 for display. Yet another widget 228 may receive alarm/event information from the presentation server which has been aggregated at the presentation server or at an aggregation/normalization service between the presentation server and a plurality of BMS subsystems.

Referring now to FIG. 2D, a flow chart of a process 250 for completion by a presentation server and for creating and sending a presentation description to a graphical user interface engine of a client device is shown, according to an exemplary embodiment. A user enters login information to the graphical user interface on the client device and the login information is provided to the presentation server. When the login information for a user is validated (step 252) by the presentation server (e.g., or by a validation resource available to the presentation server), group or user access information for the user is retrieved (step 254). The associated group may include a description of which widgets are to be displayed or otherwise made available for the user (e.g., widgets associated with administrative tasks may not be made available to regular users of GUI 200). Permissions for the widgets to be displayed (step 256) and for all the resources defined in each widget are also retrieved (step 258). The permissions may include a description of which information is made available in each widget to the user (e.g., device status information may be made available to a maintenance person responsible for maintaining the BMS). Permission metrics, a navigation tree, or other presentation descriptions are then created (step 259) based on the retrieved information. The presentation description is then sent from the presentation server to a GUI engine of a client device for local loading and rendering of a customized display at the GUI engine and client device (step 261).

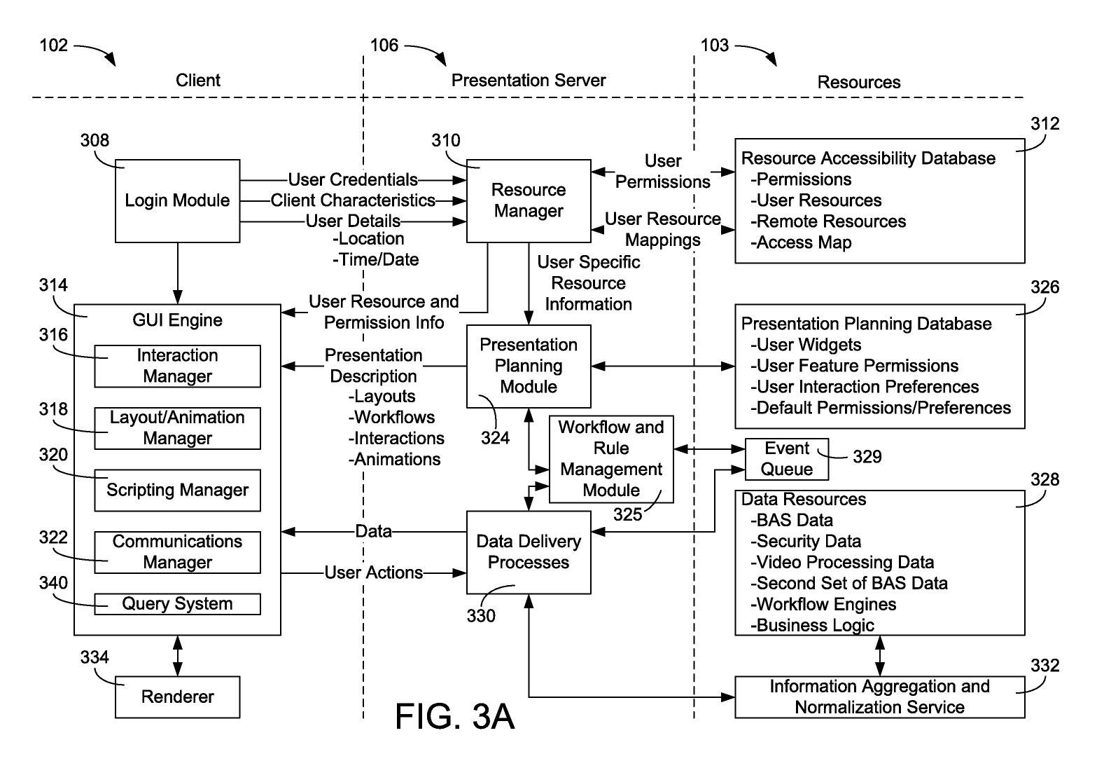

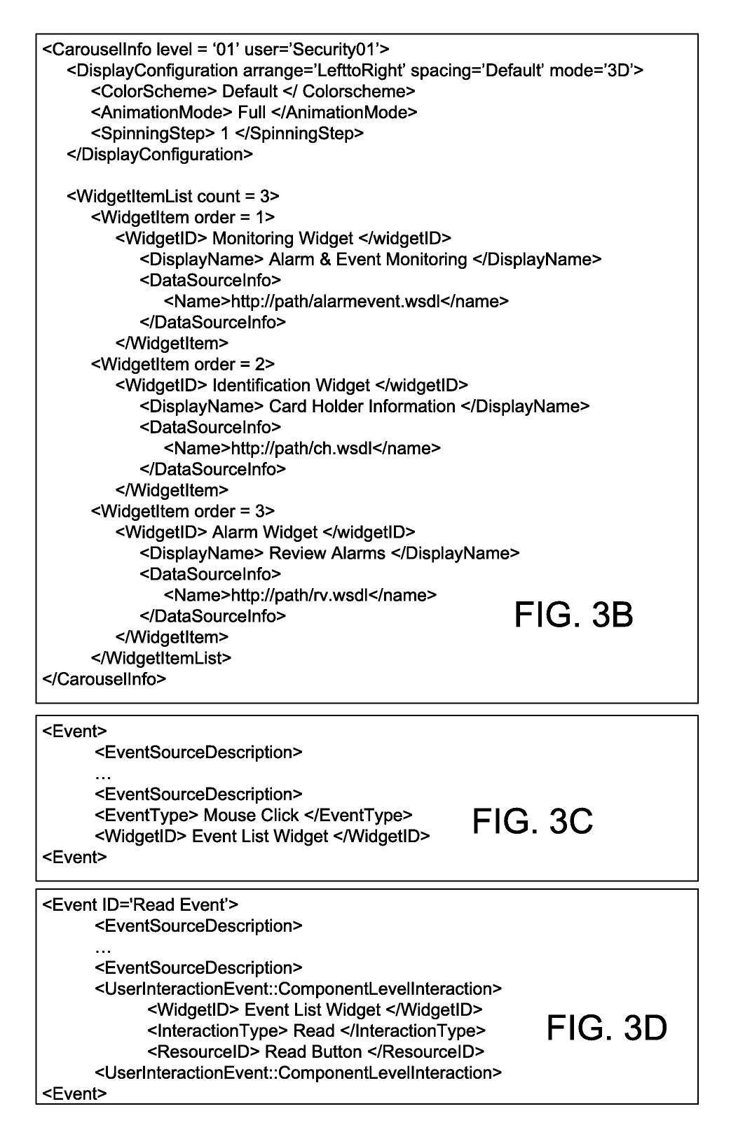

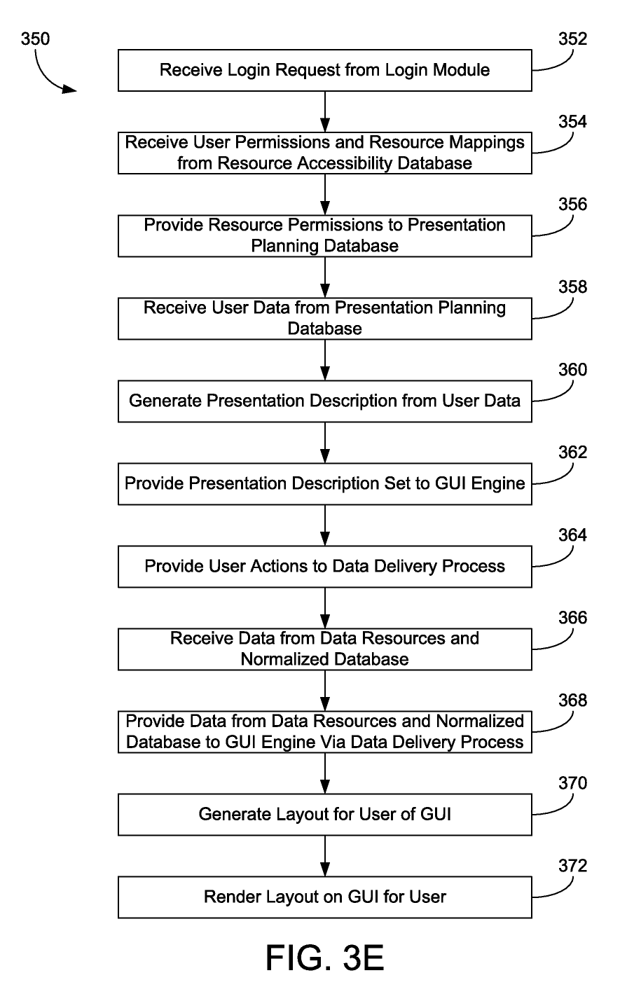

Referring now to FIG. 3A, a detailed diagram of a BMS system such as BMS 100 in FIG. 1 is shown, according to an exemplary embodiment. Client 102 is shown to include a login module 308, a GUI engine 314, and a renderer 334. In an exemplary embodiment, client 102 includes a stand-alone application including these components. In other embodiments, client 102 includes a more general purpose browser or other client platform configured to facilitate the execution or other utilization of login module 308, GUI engine 314, and renderer 334.

Client 102 and presentation server 106 each include one or more processors configured to execute computer code stored in computer readable media (e.g., a CDROM, hard disk memory, solid state memory, RAM, ROM, remotely located media, etc.). Each module, manager, system or database or resource shown in FIG. 3A is stored in memory of client 102, presentation server 106, another computing device, or media readable by such computing devices. Further, each module, engine, manager or other active component of client 102 and presentation server 106 may be computer code modules stored in memory or other computer media and configured for execution by one or more processors (e.g., general purpose processors, specific purpose processors, etc.).

Login module 308 may be configured to cause a login screen or prompt to be displayed to a user of the system and to receive login information such as user credentials from the user. The credentials of the user (e.g., username, password, pin number, multi-factor authentication information, etc.) may be gathered by login module 308 and provided to a resource manager 310 of presentation server 106. Information in addition to user credentials may be gathered by login module 308. For example, login module 308 may be configured to determine and communicate client characteristics such as the location of the client, the time and date at the client, the network address of the client, the display resolution of the client, available memory at the client, network speed at the client, colors available for display at the client, or other information specific to the client device or the user.

Presentation server 106 is shown to include a resource manager 310 that receives the user credentials, client characteristics, or other user details from client 102 and login module 308. Resource manager 310 is configured to check the information received from login module 308 against information stored in resource accessibility database 312. In an exemplary embodiment, resource manager 310 uses resource accessibility database 312 to retrieve or receive permissions information and resources information for the GUI session being initiated by the user at the client. For example, if the user credentials received by login module 308 and resource manager 310 are related to a front-desk security guard having a large and high resolution display for viewing security video, resource accessibility database 312 may provide resource manager 310 with security-related user permissions, access to data stores relating to high resolution video, and other related information. Resource manager 310 may additionally be configured to receive data from an external validation system external of the BMS system for retrieving or receiving permissions information and resources information.

Presentation server 106 is further shown to include a presentation planning module 324. Presentation planning module 324 is generally configured to use inputs from resource manager 310 (and indirectly client 102 and resource accessibility database 312) to generate a presentation description and to provide the generated presentation description to GUI engine 314. Using the presentation description, GUI engine 314 is configured to provide a highly customized and interactive GUI to the user. Presentation planning module 324 is configured to use the user specific resource information received from resource manager 310 to determine, for example, which widgets to cause the GUI engine 314 to display, which widgets to make available for selection to a user, which activities or features to cause GUI engine 314 to enable for the user, which interaction preferences are preferred by the user, or whether any default permissions or preferences should be used. Presentation planning module 324 may conduct such determinations by retrieving information, for example, from a presentation planning database 326. Presentation planning database 326 is shown to store user widgets (e.g., user widget information, user widget resources such as graphics, etc.), user feature permissions, user interaction preferences, and information regarding default permissions or preferences.

The presentation description (e.g., preferred presentation parameters) generated by presentation planning module 324 may include a description of a layout for the widgets or other information to be used by GUI engine 314, a description of workflows to be followed by GUI engine 314, a description of interactions that the user is authorized to view and manage, animations to be enabled by the GUI engine, or other presentation details. The presentation description may be one or more XML files, text files, data files, streams of data provided to GUI engine 314, or otherwise. A simplified example of such a presentation description is shown in FIG. 3B.

Referring also to FIG. 3B, an exemplary illustration of a presentation description is shown. The presentation description may be formatted according to XML or another description language. The presentation description is shown to include a field for identifying a color scheme, an animation mode (e.g., for setting how the carousel moves), and a spinning step (e.g., for setting how fast the carousel spins) for a carousel. The presentation description further includes definitions of a plurality of widget items (e.g., for loading in windows of the carousel). In the embodiment of FIG. 3B, three widget items are defined (a monitoring widget, identification widget, and alarm widget). Each widget item may include an ID, a display name associated with the widget item, and a data source of information for the widget item. The data source of information may point or provide a path to a service definition (e.g., a definition of how to interact with the service, parameters of the service, etc.) for the associated widget. For example, for an identification widget, the data source of information may point to an human resources service definition which describes the human resources service for the widget or for a data delivery process to be used by the widget. As another example, for an alarm widget, the data source of information may point to a service for providing alarms and alarm information. In general, GUI engine 314 can use the service definition for each widget to direct events or requests relating to each widget to the proper data delivery process (e.g., service, web service, widget service). For example, GUI engine 314 may use the service definition for the identification widget to direct events or requests relating to the identified user, use the service definition for the alarm widget to direct requests relating to current alarms, etc.

In addition to the information from presentation planning database 326, presentation planning module 324 may also receive information from a workflow and rule management module 325. Workflow and rule management module 325 may include descriptions, scripts, executables, or other resources that presentation planning module 324 can forward to GUI engine 314 or describe to GUI engine 314. Workflow and rule management module 325 may be configured to adjust workflows or rules given real time or near real time events of the BMS subsystems or resources 103. These events may be received at workflow and rule management module 325 from, for example, an event queue 329. Workflow and rule management module 325 may use received event information to provide dynamic workflows to GUI engine 314 rather than “canned” or “static” workflows. For example, an event in a security system and held in event queue 329 might indicate that security has recently been breached. Workflow and rule management module 325 may be configured to interpret this event and to adjust the workflow for a front desk guard (e.g., the front desk guard is shown a picture of a person attempting to access the building and is provided with a dialog box requesting that the guard confirm that the picture matches the person). If an event indicating high security is not present, workflow and rule management module 325 may describe a workflow to GUI engine 314 that does not include the confirming step when a person accesses the door.

GUI engine 314 is shown to receive the presentation description from presentation planning module 324 along with user resource and permission information from resource manager 310. When client 102 is first logging into BMS 100, GUI engine 314 uses the presentation description and the user resource and permission information to prepare the initial GUI layout and to load the initial widgets in the GUI. GUI engine 314 also uses information regarding workflows, interactions, and animations to load appropriate resources into memory or to set variables in memory so that GUI engine 314 will behave properly. GUI engine 314 operates in conjunction with renderer 334 to render the actual graphical output for display. Renderer 334 may be configured to interpret many different types of graphics, videos, layout descriptions, scripting features, or other media to complete its rendering tasks. According to an exemplary embodiment, preparing, loading, and rendering the widgets may be completed by GUI engine 314 without downloading or receiving the widget from another source (e.g., the widget may be loaded locally). GUI engine 314 may synchronize data for the widgets visible on the graphical carousel, according to an exemplary embodiment (e.g., the same data may be used for more than one widget).

GUI engine 314 is shown to include an interaction manager 316, a layout/animation manager 318, a scripting manager 320, a communications manager 322, and a query system 340.

Interaction manager 316 is generally configured to handle user inputs at the GUI. For example, a user may select a widget of the GUI (via a mouse click, a touchpad, or another input method) or a particular aspect of the widget and interaction manager 316 may receive an indication of the selection.

FIG. 3C is an illustration of an exemplary user action description provided to the presentation server or data delivery process thereof from the GUI engine. The user action description of FIG. 3C is generated by GUI engine 314 and interaction manager 316 more particularly. The user action description may be formatted according to XML or another description language. The description shown in FIG. 3C includes a description of the source of the input (e.g., the user), the type of input (e.g., a mouse click, a touch on a screen, etc.), and the widget selected. This information may be provided from interaction manager 316 to a data delivery process of the presentation server and associated with the identified widget. The data delivery process may parse the user action description to determine how the user has interacted with a widget and whether to provide any data to the GUI engine in response to the data. The data delivery process may, for example, determine that the user action should be checked against a workflow engine or business logic associated with the widget. The workflow engine or business logic may respond to the data delivery process with data for providing back to the GUI engine and for display on the widget, for launching another widget, for action by a script of the client (e.g., handled by scripting manager 320, etc.).

FIG. 3D is an illustration of another exemplary user action description provided to the presentation server or data delivery process thereof from the GUI engine. The description of FIG. 3D may be provided from the GUI engine when a user interacts with a user interface element (e.g., button, edit box, calendar, etc.) of a widget, according to an exemplary embodiment. The description of FIG. 3D is shown to include a description of the source of the input (e.g., the user), an identification of the widget the interaction is associated with, the type of interaction requested (e.g., to create, read, update, or delete), and an identification associated with the interaction (e.g., a button ID, calendar ID, etc.).

Layout/animation manager 318 is configured to use the received layout or animation information from the presentation description to generate layouts for the content to be displayed in the GUI and to generate animations. For example, layout/animation manager 318 may be configured to read information regarding animations received from presentation planning module 324 to determine how to transition from displaying a first set of widget content to a second set of widget content. In another example, a system administrator may be provided a more powerful widget or a layout that provides for greater configuration capabilities than a security guard that may only be shown a camera view and personnel information in a simple layout.

Scripting manager 320 is configured to manage widget-to-widget interactions or events or widget-to-process interactions beyond basic user manipulations or data updates. For example, scripting manager 320 may be configured to receive data regarding an event, alarm, or other action from another system of the building (e.g., from data delivery processes 330, from workflow and rule management module 325, from event queue 329, etc.). Scripting manager 320 may further be configured to cause widgets to be launched, displayed, or changed on the GUI without a user prompt. For example, if an alarm event is received from data delivery processes 330 (e.g., via event queue 329, via a security system, etc.), scripting manager 320 may receive the alarm event and launch a widget on the GUI without prompting or otherwise receiving an input from the user regarding the alarm event. Where the proper widget is already loaded, scripting manager 320 may cause, for example, the widget to become focused (e.g., by rotating a display carousel, by causing particular data to be displayed on a widget reporting “real time” status information, etc.). When configured in this way, scripting manager 320 may be configured to handle “pushed” events or data in a way that is intuitive to the user. For example, when an event is “pushed” to the client, scripting manager 320 may determine that another widget should be moved out of the way (e.g., via a sliding animation) rather than closed or replaced by a new widget relevant to the event. Scripting manager 320 may operate or communicate with other modules or managers of GUI engine 314 to complete such tasks. For example, scripting manager 320 may utilize layout/animation manager 318 to determine how to complete the scripting manager's next action in a way that is consistent with the layouts and animations requested or described by presentation planning module 324.

Communications manager 322 is configured to receive and transmit data between the GUI engine and data delivery processes 330 of presentation server 106. The communications protocol between communications manager 322 and data delivery processes 330 is intended to be simple and bandwidth light. An example of a user action message provided by communications manager 322 to data delivery processes 330 is shown in FIG. 3D. Similarly simplified messages can be provided from data delivery processes 330.

Query system 340 may be configured to generate a query based on received user data from presentation planning module 324 and resource manager 310. Query system 340 may use the information to define the data to be searched for by data delivery processes 330 or a connected system (e.g., workflow engines, business logic, etc.).

Data delivery processes 330 are configured to receive a data request from GUI engine 314. The data request may include a data resource identifier (e.g., BAS data, security data, video data, etc.), an action identifier (e.g., how and where to search for the data), and a value identifier (e.g., a specific value of data requested, such as data from a video camera, a setpoint from a HVAC component, etc.). The received data request may be formatted independently of the viewable layout of the GUI, and may not be directed to a particular database location (e.g., the data request may not specify a location to search for data). Data delivery processes 330 are further configured to receive data from data resources 328 and/or BMS subsystems and resources 103. For example, one data delivery process of processes 330 may query data resources 328 and receive responses to such queries. Another data delivery process of processes 330 may be configured to receive subscribed or streaming data from one or more data resources 328. In yet another example, each input to a widget presented by GUI engine 314 may be communicated from a corresponding data delivery process to GUI engine 314. The data delivery processes 330 may be available to a plurality of connected clients and GUI engines as data services. In an exemplary embodiment, the data is normalized and stored at information aggregation and normalization service 332. Data delivery processes 330 may receive user actions (e.g., user queries, user entries, user requests, etc.) from GUI engine 314 when they are initiated by one or more user events, widget events, or otherwise. The user actions may be used by data delivery processes 330 or other processes (e.g., business logic or workflow engines of resources 328) to determine the data to be searched for and/or retrieved.

GUI engine 314 may include the process of preloading and pre-rendering a widget using the received presentation resources. The preloading and pre-rendering of the widget may be completed before providing a data request to data delivery processes 330 for receiving data for the widgets. According to an exemplary embodiment, GUI engine 314 may include logic for estimating when or if a user will cause a widget currently obscured from view in the graphical carousel to be brought into view, and GUI engine 314 may initiate the preloading the pre-rendering step in response to the estimation (e.g., if a user is rotating the graphical carousel, a widget about to be rotated into view may be preloaded and pre-rendered so that the widget may be displayed when it is brought into view). According to another exemplary embodiment, GUI engine 314 may receive an event message from presentation server 106 and may preload and pre-render a widget in response to the event message before the widget is shown on the carousel. A query for data for the widget being pre-loaded may be made before causing the carousel to be displayed to the user.

Referring now to FIG. 3E, a flow chart of a process 350 for using the GUI system of FIG. 3A to generate a display for a user is shown, according to an exemplary embodiment. A login request may be received at the login module from a user (step 352). Based on the user requesting the information, user permissions and resources mappings may be determined, and the resource manager may receive the permissions and mappings from the resource accessibility database (step 354). User specific resource information (e.g., including the permissions and mappings) may then be provided from the resource manager to the presentation planning system (step 356).

Data regarding the user may be received by the presentation planning system from the presentation planning database (step 358) (e.g., in response to a request for such information from the presentation planning system). Using the user data and resource permissions, the presentation planning system may generate a presentation description (step 360) (e.g., shown in FIG. 3B) and provide the presentation description to the GUI engine (step 362).

The data delivery processes may receive user actions from the presentation planning database (step 364) and may receive data from various data resources of the building area and from the normalized database (step 366). Step 366 may additionally include generating a business logic and/or data streaming plan based on the received data from the data resources. The data may then be provided to the GUI engine (step 368) and the GUI engine may used all the received data to generate a layout for the user (step 370). The renderer may receive the layout and render the layout on the GUI for the user (step 372).

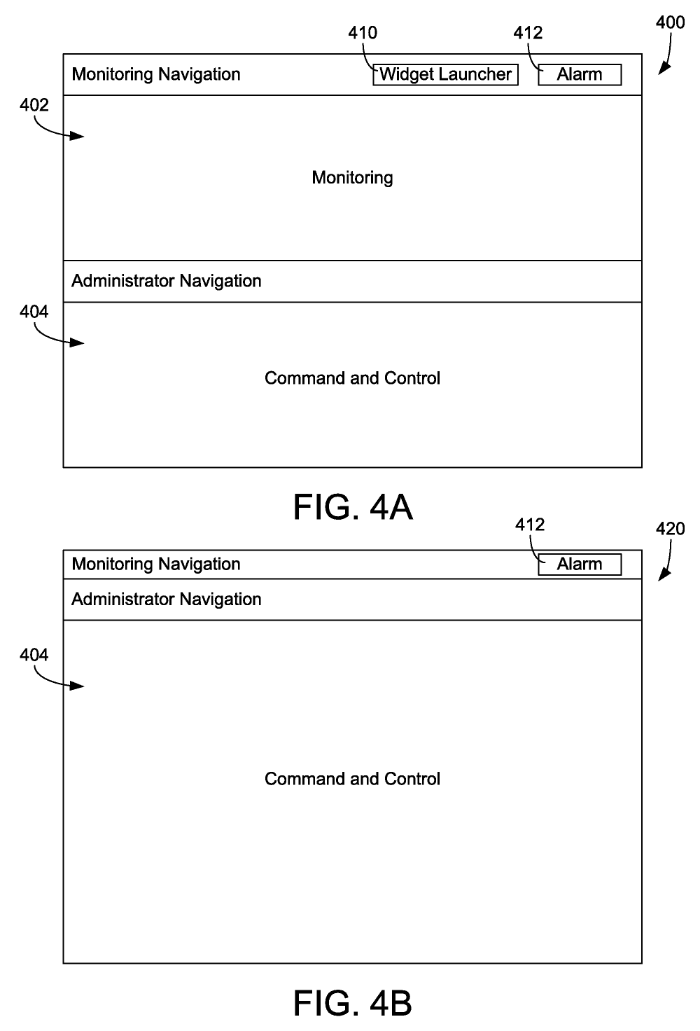

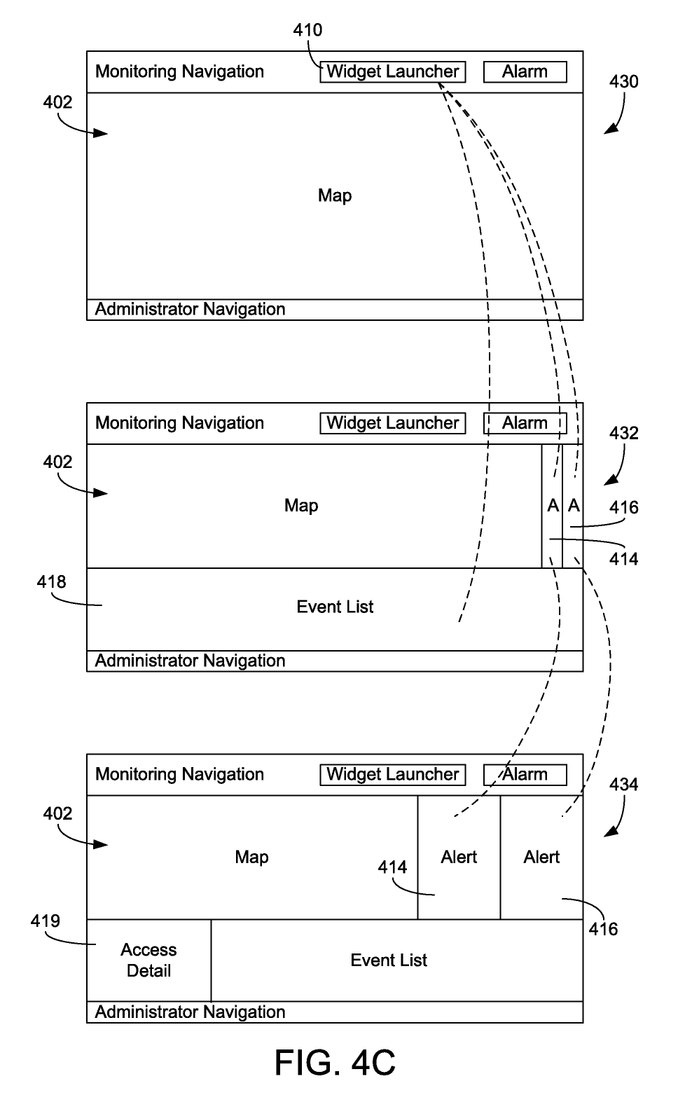

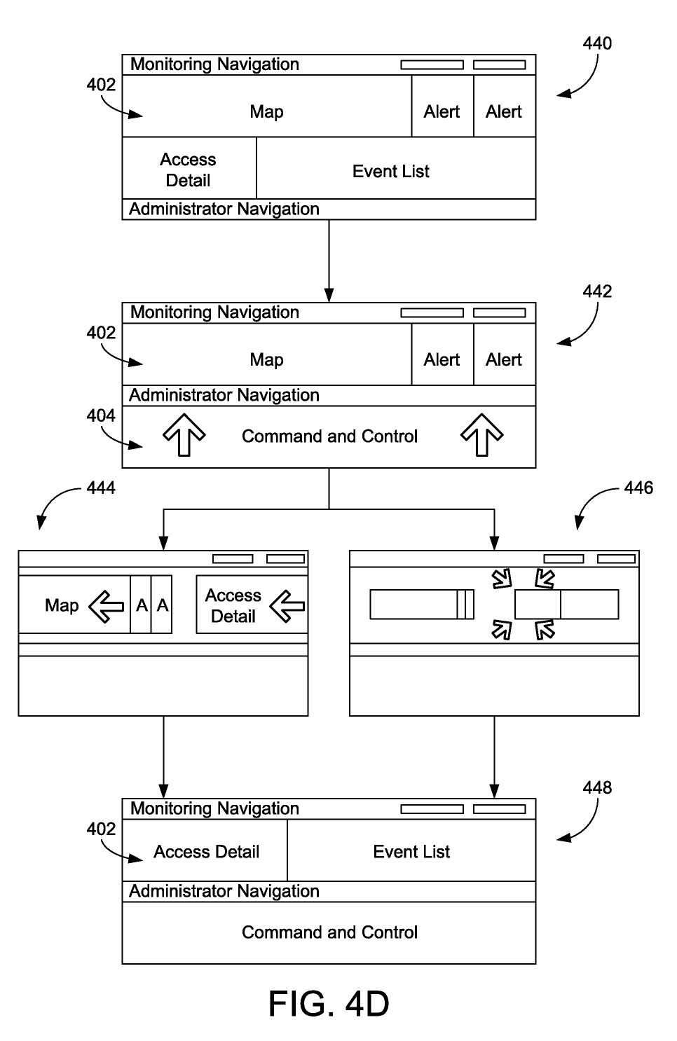

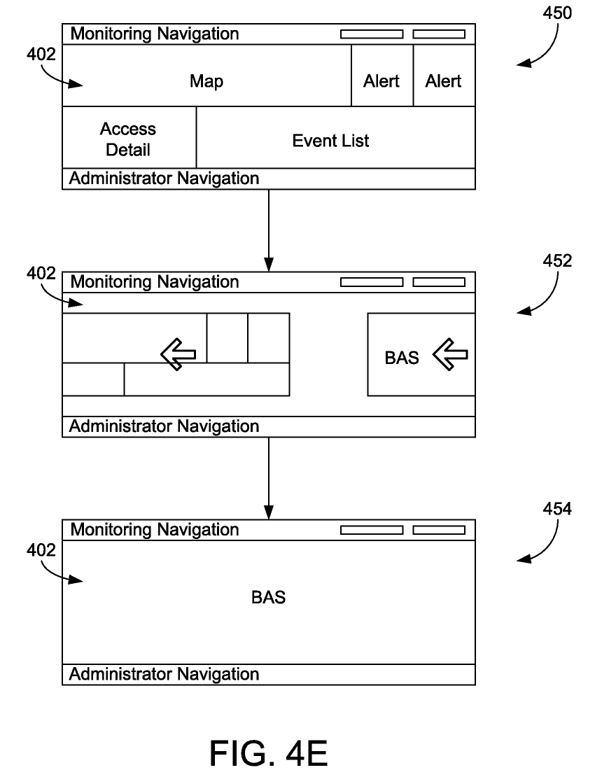

Referring generally to FIGS. 4A-E, various illustrations of GUIs that may be generated by the GUI engine of the client are shown in greater detail. The GUI windows are shown to include a monitoring pane 402 (as described in FIGS. 2A-B) and an administration pane 404 (e.g., a “command and control” pane). Each pane 402, 404 may be configured to include or host one or more widgets or graphical controls for hosting widgets. For example, pane 402 may include or host the graphical carousel of FIGS. 2A-B and widgets hosted within windows of the graphical carousel.

Monitoring pane 402 may be configured to include a widget (e.g., as selected or hosted by a graphical carousel) that displays content to be monitored by a user of GUI window 400. For example, information displayed in monitoring pane 402 may include a map, an event list, system status for a plurality of systems, one or more alarms, etc. Administration pane 404 may be configured to provide access to administration tasks for a user of GUI window 400 (if the user is authorized to have access to the administration tasks). For example, administration pane 404 may be used to access one or more reports regarding various systems of the building area.

GUI window 400 further includes GUI controls 410, 412 that may be selected by a user to activate portions of GUI window 400. For example, widget launcher 410 may be clicked or otherwise selected to display a tool for allowing a user to launch new widgets (e.g., a security widget, a temperature trending widget, etc.). Alert indicator 412 may be used to indicate the presence of an alarm to a user of GUI window 400. Alert indicator 412 may change states (e.g., “light up”, flash, change colors, etc.) or otherwise provide an indication of a new alert regarding the building area to the user of GUI window 400.

Referring now to FIG. 4B, GUI window 420 is shown with a larger administration pane 404 and a minimized monitoring pane 402. According to an exemplary embodiment, administration pane 404 may be enlarged (e.g., automatically, by user selection and dragging, etc.) when a user of GUI window 420 is performing administration tasks. According to various exemplary embodiments, the sizes of the various panes of the GUI window of FIGS. 4A-E may be altered based on the functions being performed by the user.

Referring to FIG. 4C, an illustration of exemplary GUI windows that may be generated by the GUI engine are shown. GUI window 430 is shown with monitoring pane 402 displaying a map for a user. GUI window 430 may be configured to provide a full screen display. A user of GUI window 430 may then “click” or otherwise activate widget launcher 410. Referring now to GUI window 432, the activation of widget launcher 410 provides various new widgets 414, 416, 418 for a user of the GUI window. For example, in GUI window 432, widgets 414, 416 are alert widgets that may be generated by the GUI system when an alert is issued in the building area. Widget 418 may be or include an event list for listing detected or scheduled events in the building area. Widget launcher 410 may additionally launch any number of widgets (e.g., via displaying a graphical carousel) related to the application being shown in GUI window 432 or may present a list of available widgets to a user for launching.

Referring now to GUI window 434, widgets 414, 416, 418 may be further expanded. A user may expand or minimize any portion of GUI window 434 for viewing information provided by the various widgets of GUI window 434. For example, alert widgets 414, 416 may be expanded to view further details regarding the generated alert. As another example, event list 418 may be further expanded to show access detail 419 for viewing building access monitoring (e.g., which users of the building have accessed a building area or building system) or otherwise.

Referring now to FIG. 4D, an illustration of using the GUI window to navigate between content of an application is shown, according to an exemplary embodiment. Referring to GUI window 440, monitoring pane 402 is shown displaying an application including content such as a map, one or more alerts, and an event list including an access detail is shown. In GUI window 442, administration pane 404 shown, obscuring the bottom portion of monitoring pane 402.

When a portion of monitoring pane 402 is obscured, the user may choose to navigate between the content shown and the content not shown in monitoring pane 402. For example, in GUI window 444, a user may navigate between the portion showing the map and alarm and the portion showing the event list and access detail. The user may rotate or scroll across the different content and select the content he or she wishes to view. Referring also to GUI window 446, monitoring pane 402 may be configured to show all content windows for an application such that a user may select the content to view. In GUI window 448, the portion including the event list and access detail is shown selected and displayed in monitoring pane 402.

Referring now to FIG. 4E, an illustration of using the GUI window to navigate between applications is shown, according to an exemplary embodiment. In GUI window 450, an application is shown in monitoring pane 402. A user may then switch between applications by rotating, scrolling, or otherwise navigating across multiple applications as shown in GUI window 452. A user may then select another application (e.g., a BAS application) for view, as shown in GUI window 452.

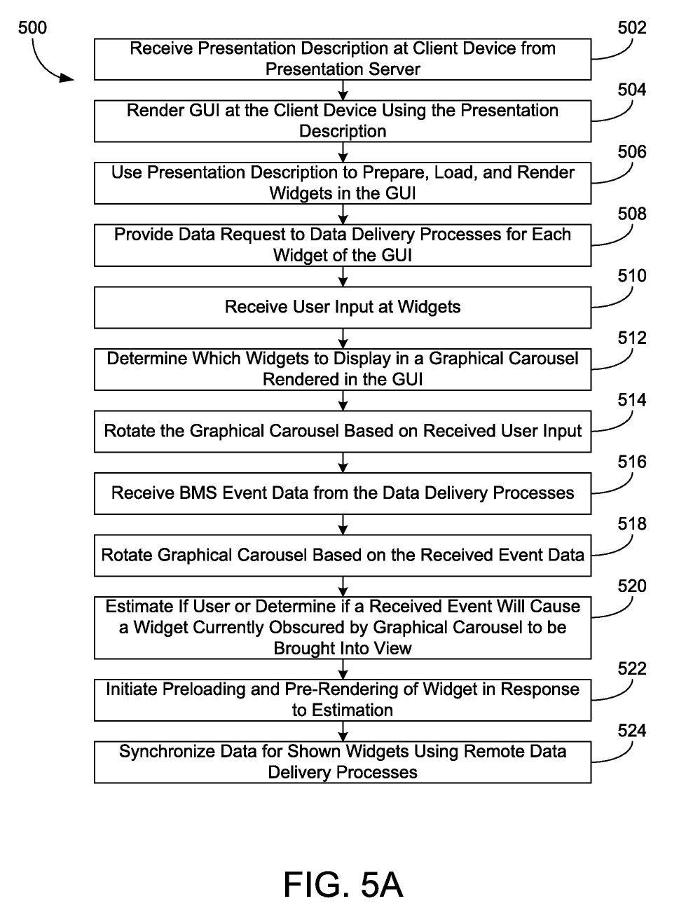

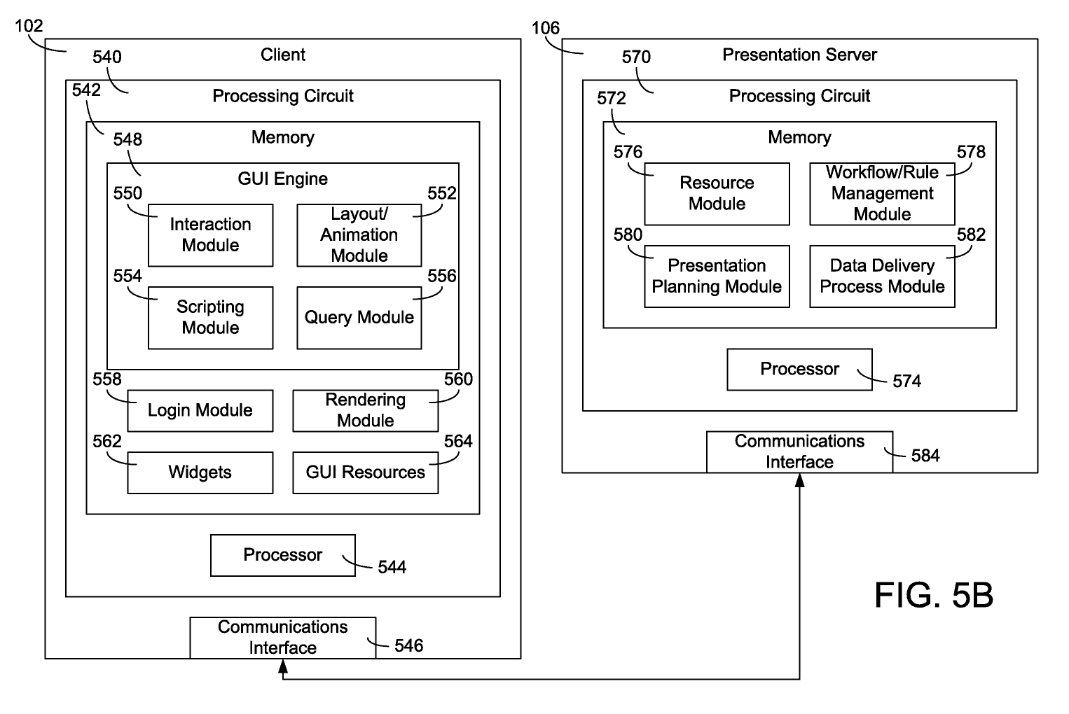

Referring now to FIG. 5A, a flow chart of a process 500 for generating a graphical user interface for a building management system at a client device is shown, according to an exemplary embodiment. Process 500 includes receiving a presentation description for the GUI from the presentation server (e.g., presentation server 106) (step 502). A GUI is rendered at the client device using the presentation description (step 504). Further, using the presentation description received in step 502, widgets may be prepared, loaded, and rendered (step 506) by a GUI engine at the client device. The GUI engine or other process of the client device can provide a data request to data delivery processes running on the presentation or another remote BMS resource (step 508).

Process 500 further includes receiving a user input at the widgets (step 510). The user input may relate to the selection of a widget, the rotation of a graphical carousel hosting multiple widgets, or another function associated with the GUI. Based on the user input and/or the presentation description received from the presentation server, a determination as to which widgets to display in the graphical carousel may be made (step 512) and the graphical carousel may be rotated as a result (step 514). For example, a user request to rotate the graphical carousel to the left or right may result in an animation of some widgets rotating out of view while other widgets rotate into view. The widgets to be rotated into view may be loaded and rendered before their actual display is necessary so that the animation of rotation may be as smooth as possible.

Process 500 further includes receiving BMS event data (step 516) or an event message from the data delivery processes at the presentation server and associated with widgets displayed at the client. The graphical carousel may be rotated based on the received event data (step 518). For example, an event such as an alarm may be received, and it may be determined that a widget associated with the event should be immediately displayed on the graphical carousel. The graphical carousel may then rotate to show the widget associated with the event. Steps 516-518 may additionally include a preloading and pre-rendering step where the widget is preloaded and pre-rendered before being displayed on the graphical carousel.

Process 500 further includes estimating if a user or a received event will cause a widget currently obscured by the graphical carousel to be brought into view (step 520). For example, the user may be rotating the graphical carousel and may be rotating closer to specific widgets, the user may be searching for a particular type of widget, or otherwise. A preloading and pre-rendering of a widget may be initiated (step 522). For example, for a widget identified in step 520, the widget may be preloaded and pre-rendered such that the widget is ready to be displayed if the graphical carousel is rotated such that the widget is to be displayed. Process 500 further includes synchronizing data (e.g., by requesting data updated from the presentation server) for the widgets shown in the graphical carousel (step 524).

Referring now to FIG. 5B, a block diagram of a client 102 and presentation server 106 is shown, according to an exemplary embodiment. Client 102 and presentation server 106 are each shown to include a processing circuit 540 or 570 including a processor 544 or 574 and memory 542 or 572. Processors 544, 574 may be or include one or more microprocessors, an application specific integrated circuit (ASIC), a circuit containing one or more processing components, a group of distributed processing components, circuitry for supporting a microprocessor, or other hardware configured for processing. According to an exemplary embodiment, processors 544, 574 are configured to execute computer code stored in memory 542, 572 to complete and facilitate the activities described herein. Memory 542, 572 can be any volatile or non-volatile memory device capable of storing data or computer code relating to the activities described herein. For example, memory 542, 572 are shown with various modules which are computer code modules (e.g., executable code, object code, source code, script code, machine code, etc.) configured for executing by processors 544, 574.

Memory 542 of client 102 is shown to include GUI engine 548 that may be configured to provide the functionality of GUI engine 312 described with reference to previous Figures (e.g., the functionality provided when executed by processor 544). GUI engine 548 includes an interaction module 550 configured to receive and handle user input, a layout/animation module 552 configured to generate layouts and animations for content to be displayed in the GUI, a scripting module 554 configured to manage interactions beyond user inputs and data updates, and a query module 556 configured to generate a query. Memory 542 of client 102 may further include a login module 558 configured to accept a user login and rendering module 560 for rendering a display for a GUI based on data received from GUI engine 548. Memory 542 further includes widgets 562 for generating and otherwise configuring the widgets to be provided via the GUI and graphical carousel. Memory 542 further includes GUI resources 564 for generating a GUI. Modules 550-560, widgets 562, and GUI resources 564 may have the general functionality as described in FIGS. 3A-E and the present application.

Memory 572 of presentation server 106 may include resource module 576 configured to verify a user login, workflow and rule management module 578 configured to provide presentation planning module 580 with descriptions, scripts, executables, or other resources, presentation planning module 580 configured to generate a presentation description, and data delivery process module 582 configured to receive a data request from GUI engine 548. Modules 576-582 may be configured to provide the functionality as described in FIGS. 3A-E and throughout the present application when executed by processor 574 or more generally processing circuit 570. Client 102 and presentation server 106 may include communications interfaces 546, 584 for transmitting data between client 102 and presentation server 106. For example, query module 556 may generate a query to be sent to data delivery process module 582 via interfaces 546, 584.

In an exemplary embodiment, presentation server 106 is configured to determine how to present a graphical user interface on client 102 using information received from client 102 and information received from a user permissions resource. The presentation server 106 is further configured to generate presentation descriptions and to provide the presentation descriptions to the client device based on the presentation server's determinations.

Graphical user interface engine 548 is local to client 102 (e.g., is stored in memory of client 102) and is configured to receive and parse the presentation descriptions received from presentation server 106 to load and render graphical user interface widgets 562 stored in memory 542 local to the graphical user interface engine 548 using local processing resources (e.g., 540, 544). The graphical user interface engine 548 is further configured to provide requests to data delivery processes 582 of the presentation server 106 to gather building management system data for the graphical user interface widgets 562. The graphical user interface engine 548 causes the graphical user interface widgets populated with data received in response to the requests to be displayed in a graphical user interface and on an electronic display connected to the client 102.

In an exemplary embodiment, the graphical user interface engine 548 is configured to load the graphical user interface widgets 562 stored in memory 542 in response to the presentation description received from presentation server 106 without receiving the widget from the presentation server. The graphical user interface caused to be displayed by GUI engine 548 can include a graphical representation of a three dimensional object, where one or more surfaces of the graphical representation of the three dimensional object include a plurality of windows, and each window is configured to host a widget for displaying information from the building management system.

Data delivery processes of the system may include or communicate with business logic or business services that use building management system information available from a building management system subsystem or a service configured to aggregate and normalize data from a plurality of building management system subsystems. The business logic may be configured to complete a series of a processing steps according to a business workflow. The business logic may be configured to interact with at least two BMS subsystems to complete the series of processing steps—allowing for complex business processes to be completed without such processes being exposed to clients. Further, business processes can be changed or handled in ways that are dynamic or transparent to the client. The data delivery processes are configured to gather results from the business logic and to report the results to the graphical user interface engine 548 for display in a graphical user interface widget.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the application. Likewise, software implementations could be accomplished with standard programming techniques with rule based logic and other logic to accomplish the various connection steps, processing steps, comparison steps and decision steps.

What is claimed is:

1. A method for generating a graphical user interface for a building management system at a client device, the method comprising:
rendering a graphical representation of a three dimensional object in the graphical user interface, wherein one or more surfaces of the graphical representation of the three dimensional object include a plurality of windows, each window configured to host a widget for displaying information from the building management system;
receiving data from the building management system for the widgets;
rendering the widgets using the data received from the building management system; and
interpreting user input and rotating the graphical representation of the three dimensional object based on the interpretation.

2. The method of claim 1, wherein the further comprising:
receiving user input and interpreting the user input to determine which of a plurality of possible widgets to include in the windows on the graphical representation of the three dimensional object.

3. The method of claim 1, wherein the graphical representation is of a cylinder and the side surface of the cylinder includes the plurality of windows configured to host widgets for displaying information from the building management system.

4. The method of claim 1, wherein the widgets hosted by the plurality of windows include a first widget configured to display video information from a video security server of the building management system.

5. The method of claim 4, wherein the widgets hosted by the plurality of windows include a second widget configured to display an HVAC alarm.

6. The method of claim 5, wherein the widgets hosted by the plurality of windows include a third widget configured to display device values from the building automation system.

7. The method of claim 1, wherein a widget of the plurality of widgets is user selectable and wherein the method further comprises:
causing a new window of information to be displayed in the graphical user interface in response to a user selection of the widget.

8. The method of claim 1, the method further comprising:
rotating the graphical representation of the three dimensional object to bring a widget into view in response to receiving event data from the building management system.

9. The method of claim 1, wherein a widget of the widgets hosted by the plurality of windows is configured to display a graphical representation of multiple layers stacked and extending away from the surface of the three dimensional object.

10. The method of claim 1, further comprising:
receiving a description of preferred presentation parameters for the graphical user interface from a presentation server associated with the building management system;
using the description to prepare, load, and render the widgets for the graphical representation of the three dimensional object; and
providing a data request to a data delivery process of the presentation server, wherein the data received from the building management system is in response to the data requests.

11. The method of claim 10, wherein the step of using the description to prepare, load, and render is completed by the computing device without downloading or receiving the widget from another source.

12. The method of claim 10, wherein the data request comprises:
a data resource identifier;
an action identifier; and
a value identifier.

13. The method of claim 12, wherein the data request is formatted independently of the viewable layout of the graphical user interface.

14. The method of claim 12, wherein the data request is not directed to a particular database location.

15. The method of claim 10, the method further comprising:
preloading and pre-rendering a widget using presentation resources of the computing device.

16. The method of claim 15, wherein the preloading and pre-rendering is completed prior to providing the data request to the data delivery process of the presentation server.

17. The method of claim 15, wherein the method comprises:
estimating that the user will cause a widget that is currently obscured from view to be brought into view; and
initiating the preloading and pre-rendering of the widget in response to the estimation.

18. The method of claim 17, wherein the method comprises:
prior to causing the carousel to be displayed to the user, querying for data for the widget that is pre-loading from the presentation server.

19. The method of claim 17, wherein the method comprises:
receiving an event message from the presentation server;
initiating the preloading and pre-rendering of the widget in response to the event message.

20. The method of claim 10, wherein the method further comprises:
synchronizing data for the widgets visible on the graphical representation of the three dimensional object.

21. Computer-readable media with computer-executable instructions embodied thereon that when executed by a computing device perform a method for generating a graphical user interface for a building management system, the media comprising:
instructions for rendering a graphical representation of a three dimensional object in the graphical user interface, wherein one or more surfaces of the graphical representation of the three dimensional object include a plurality of windows, each window configured to host a widget for displaying information from the building management system;
instructions for receiving data from the building management system for the widgets;
instructions for rendering the widgets using the data received from the building management system; and
instructions for interpreting user input and rotating the graphical representation of the three dimensional object based on the interpretation.

22. A system for displaying a graphical user interface for a building management system on a client device, the system comprising:
a presentation server configured to determine how to present the graphical user interface on the client device using information received from the client and information received from a user permissions resource, the presentation server further configured to generate presentation descriptions and to provide the presentation descriptions to the client device; and
a graphical user interface engine local to the client device and configured to receive and parse the presentation descriptions received from the presentation server to load and render graphical user interface widgets stored in memory local to the graphical user interface engine using local processing resources, wherein the graphical user interface engine is further configured to provide requests to data delivery processes of the presentation server to gather building management system data for the graphical user interface widgets;
wherein the graphical user interface engine is further configured to cause the graphical user interface widgets populated with data received in response to the requests to be displayed in the graphical user interface and on an electronic display connected to the client device.

23. The system of claim 22, wherein the graphical user interface engine is further configured to load the graphical user interface widgets stored in memory in response to the presentation description and without receiving the widget from the presentation server.

24. The system of claim 23, wherein the graphical user interface comprises a graphical representation of a three dimensional object in the graphical user interface, wherein one or more surfaces of the graphical representation of the three dimensional object includes a plurality of windows, each window configured to host a widget for displaying information from the building management system.

25. The system of claim 24, wherein the data delivery processes include business logic that uses building management system information available from at least one of a building management system subsystem and a service configured to aggregate and normalize data from a plurality of building management system subsystems.

26. The system of claim 25, wherein the business logic is configured to complete a series of a processing steps according to a business workflow.

27. The system of claim 26, wherein the business logic is configured to interact with at least two building management system subsystems to complete the series of processing steps.

28. The system of claim 27, wherein the data delivery processes are configured to gather results from the business logic and to report the results to the graphical user interface engine for display in a graphical user interface widget.
